(19) United States
(12) Patent Application Publication
(10) Pub. No.: US 2019/0379926 A1
(43) Pub. Date: Dec. 12, 2019

(54) METHOD OF OPTIMIZING MEDIA USED TO DISPLAY MOVING IMAGES

(71) Applicant: MICROSOFT TECHNOLOGY LICENSING, LLC, Redmond, WA (US)

(72) Inventors: Tanel VARI, Redmond, WA (US); Sergio Eduardo Rodriquez VIRGEN, Bothell, WA (US); Jaak PARIK, Tallinn (EE)

(73) Assignee: MICROSOFT TECHNOLOGY LICENSING, LLC, Redmond, WA (US)

(21) Appl. No.: 16/001,928

(22) Filed: Jun. 6, 2018

(51) Int. Cl. H04N 21/435; H04N 21/84; H04N 21/472

(52) U.S. Cl. CPC H04N 21/4355; H04N 21/472; H04N 21/84

(57) ABSTRACT

A method for optimizing an animation file by reducing its size without substantially modifying the quality of the animation as viewed by a user is disclosed. The solution includes assigning a metadata tag to each frame in the animation file and creating a metadata playback file to store a sequence of frames that should be played during playback of the optimized animation file. Each animation frame in the original animation file is then compared to all other previous non-repetitive frames to determine if the current frame is substantially similar to a previous one. When a frame is determined to be substantially similar, it is deleted in the optimized animation file, while a reference to the previous similar frame is included in the sequence of frames stored in the metadata playback file.

### TECHNICAL FIELD

This disclosure relates generally to optimizing media files used for displaying moving images and, more particularly, to a method of optimizing media files used for displaying moving images by eliminating similar frames.

### BACKGROUND

With the rise in use of messaging applications, there has been a significant increase in use of emoticon animations in messaging. For example, users may use emoticon animations to reinforce their text messages, to express a feeling or to use the emoticons instead of words. As a result, a large number of emoticon animations have been developed to express various feelings and/or cover a variety of situations. Before a user can use such emoticon animations in a messaging application, however, they generally need to electronically download each animation to their device. This is normally done through the Internet.

Animation files are usually relatively large. As a result, downloading a large number of emoticon animations utilizes a significant amount of bandwidth. For a messaging application that offers numerous animations for download and has a considerable number of users, this requires a lot of resources. Moreover, storing these files in a user's device takes a up a large amount of storage space.

Currently compression techniques for digital media files do not take into account the specific nature of media files used for displaying moving images such as animation files and are thus inefficient and not highly effective in reducing bandwidth and storage requirements for such files.

### SUMMARY

In one general aspect, the instant application describes a method for optimizing a media file comprising a plurality of sequential frames, wherein each of the frames is associated with a metadata tag, and the frames include a plurality of designated reference frames. The method includes creating a metadata playback file for storing a playback list for use in playback; comparing a next frame in the plurality of sequential frames to each one of the plurality of reference frames to determine if a degree of similarities between the next frame and one of the plurality of reference frames is above a threshold or a degree of differences between the next frame and the one of the plurality of reference frames is below the threshold; upon determining that the degree of similarities between the next frame and one of the plurality of reference frames is above the threshold or the degree of differences between the next frame and the one of the plurality of reference frames is below the threshold, labeling the next frame as a repeated frame, deleting the repeated frame from the media file and inserting the metadata tag for the one of the plurality of reference frames in the playback list; upon determining that the degree of similarities is below the threshold or the degree of differences is above the threshold, labeling the next frame as a next reference frame in the plurality of reference frames, and inserting the metadata tag for the next frame in the playback list; and repeating the process of comparing the next frame in the plurality of sequential frames to each of the plurality of reference frames until all the frames in the plurality of sequential frames have been compared to all of the plurality of reference frames.

In another general aspect, the instant application describes an apparatus that includes a processing unit; and a memory readable by the processing unit and comprising instructions stored thereon to cause the processing unit to: create a copy of a media file as an optimized media file; assign a metadata tag to each frame in a plurality of sequential frames in the media file; create a metadata playback file for storing a playback list for use in playback; designate a first frame in the plurality of sequential frames as a first reference frame of a plurality of reference frames; compare a next frame in the plurality of sequential frames to each one of the plurality of reference frames to determine if a degree of similarities between the next frame and one of the plurality of reference frames is above a threshold or a degree of differences between the next frame and the one of the plurality of reference frames is below the threshold; upon determining that the degree of similarities between the next frame and one of the plurality of reference frames is above the threshold or the degree of differences between the next frame and the one of the plurality of reference frames is below the threshold, label the next frame as a repeated frame, delete the repeated frame from the optimized media file and insert the metadata tag for the one of the plurality of reference frames in the playback list; upon determining that the degree of similarities is below the threshold or the degree of differences is above the threshold, label the next frame as a next reference frame in the plurality of reference frames, and insert the metadata tag for the next frame in the playback list; and repeat the process of comparing the next frame in the plurality of sequential frames to each of the plurality of reference frames until all the frames in the plurality of sequential frames have been compared to all of the plurality of reference frames.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 illustrates a number of frames that make up an original unoptimized animation file.

FIG. 2 is a flow diagram for a method for optimizing a media file used for displaying moving images.

FIG. 3 is a graphical user interface for changing an optimization threshold and displaying side by side views of an animation file and an optimized animation file.

FIGS. 4A-4B illustrate the frames in two different optimized animation files of the original unoptimized animation of FIG. 1.

FIG. 5 is a table depicting optimization parameters for a plurality of animation files optimized with the method for optimizing animation files.

FIG. 6 is a block diagram of an exemplary computer system upon which aspects of this disclosure may be implemented.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well known methods, procedures, components, and/or circuitry have been described at a relatively high-level, without detail, in order to avoid unnecessarily obscuring aspects of the present teachings. In the following material, indications of direction, such as “top” or “left,” are merely to provide a frame of reference during the following discussion, and are not intended to indicate a required, desired, or intended orientation of the described articles.

This description is related to techniques used for optimizing a media file used for displaying moving images (e.g., an animation file) to reduce its size without substantially modifying the quality of the media as viewed by a user. The techniques include creating a copy of the media file and labeling it an optimized media file, assigning a metadata tag to each frame in the media file and creating a metadata playback file to store a sequence of frames that should be played during playback of the optimized media file. Each frame in the original media file is then compared to all other previous non-repetitive frames to determine if the current frame is substantially similar to a previous one. When a frame is determined to be substantially similar, it is deleted in the optimized media file, while a reference to the previous similar frame is included in the sequence of frames stored in the metadata playback file. The degree of similarity may be pre-determined, or it may be modifiable by a designer of the media or an administrator.

As will be understood by persons of skill in the art upon reading this disclosure, benefits and advantages provided by such implementations can include, but are not limited to, a solution to the problem of large amount of bandwidth and storage required for transfer, storage and playback of animation files. Solutions and implementations provided here reduce the size of animation files without substantially reducing their viewing quality, thus increasing the speed with which an animation file can be electronically transferred, freeing up resources and reducing costs.

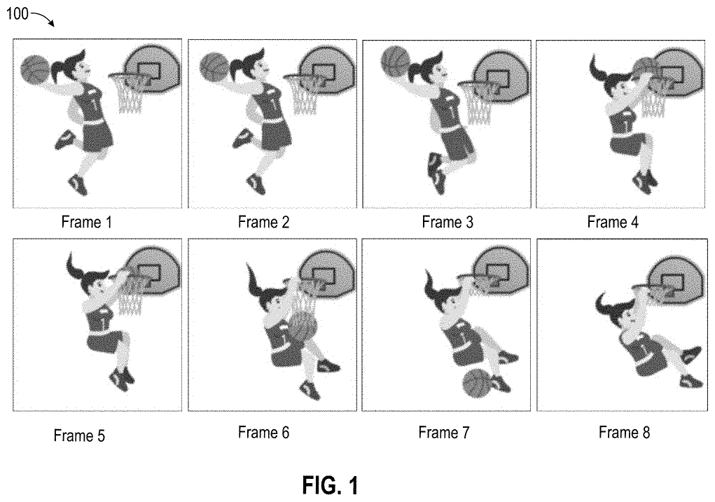

Referring now to the drawings, FIG. 1 shows an example of a few frames out of a large number of frames that make up an original unoptimized animation file 100. The frames are labeled frame 1 through frame 8 for ease of reference and relate to a woman slam dunking a basketball. When played consecutively with a player, the frames 1 through 8 display an animation of the woman jumping up and slam dunking the ball with her right hand. It should be noted that frames 1 through 8 are for illustration purposes and a real animation file may include many more frames than illustrated in FIG. 1. An animation file, as used in this disclosure, can be any file that includes frame by frame animations. These files include bitmap, png, jpg, vector frame by frame animations, or any other file having similar features.

As can be seen, some of the frames in the animation file 100 are similar to each other while others are very different. For example, frame 2 is almost identical to frame 2, while it is somewhat different from frame 3. On the other hand, frame 4 is also somewhat similar to frame 5, while still having some differences. In order to reduce the size of an animation file, such as animation file 100, substantially similar frames can be eliminated from the file. Instead, the optimized animation file may only include one of the substantially similar frames. For example, the optimized animation file for the animation file 100, may eliminate frame 2. Instead, the optimized file may replay frame 1 twice. In this manner, the size of the optimized animation file can be reduced without substantially changing the quality of the animation file as viewed by a user.

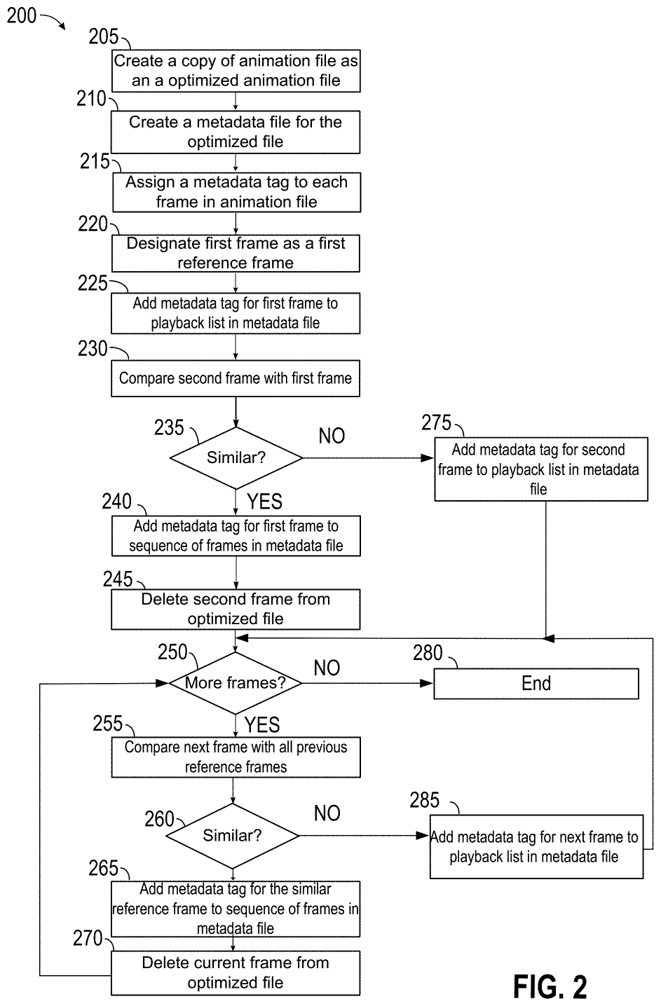

FIG. 2 is a flow diagram depicting an exemplary method 200 for optimizing a media file used for displaying moving images such as an animation file. At 205, the method 200 begins by creating a copy of the original media file and labeling it as the optimized media file. This optimized media file may then be used to optimize the media file. This may be done to keep the original media file so that optimization can be reversed and/or modified as needed. Moreover, keeping the original media file allows the animator to compare the optimized media with the original media to visually inspect the changes.

After the optimized media file has been created, method 200 may proceed, at 210, to create a metadata file associated with the optimized media file. In one implementation, the metadata file is used to store playback metadata information. For example, the metadata file may include a playback list of frames that should be played consecutively during playback. Referring back to of FIG. 1, a metadata file associated with the animation file 100 may include a sequence of numbers: 1, 2, 3, 4, 5, 6, 7, 8 for the numbers associated with the frames that should be played consecutively during playback. The metadata file may be a text file or any other file that is readable by a tool used for playback of optimized animations.

Method 200 may also include, at 215, assigning a metadata tag to each frame in the original media file. In one implementation, the metadata tag is consecutive numbers, similar to the numbers displayed in FIG. 1. For example, the method 200 may assign the metadata tag 1 to the first frame in the media file and may assign consecutive numbers to each of the next frames in the media file. Alternatively, the metadata tag may be consecutive letters of the alphabet. In other implementations, the metadata tags may be any characters that clearly identify and distinguish each frame from the others. The metadata tags for the frames may be included in the metadata file to help identify the frames during playback.

After assigning metadata tags to the frames, the method 200 may proceed, at 220, to designate the first frame in the original media file as the first reference frame. This is done to identify the first frame as a key frame with which every other file needs to be compared. That is because, at this stage, there are no other frames to compare the first frame with. As a result, the metadata tag for the first frame may be added to the playback list in the metadata file, such that the first frame is always played first during playback of the optimized media file.

Method 200 may then proceed to examine the second frame by comparing the second frame with the first frame, at 230. The comparison may be done on a pixel by pixel basis, to compare certain properties of each pixel in the second frame with the same properties of the same pixel in the first frame. The properties of the pixels may include transparency, color, and/or hue, among others. Transparency of the pixels may be compared on an 8 bit basis, which not only compares black and white transparency but also the mid-tones in between black and white. This is particularly relevant to animation files, as most animations have transparent backgrounds.

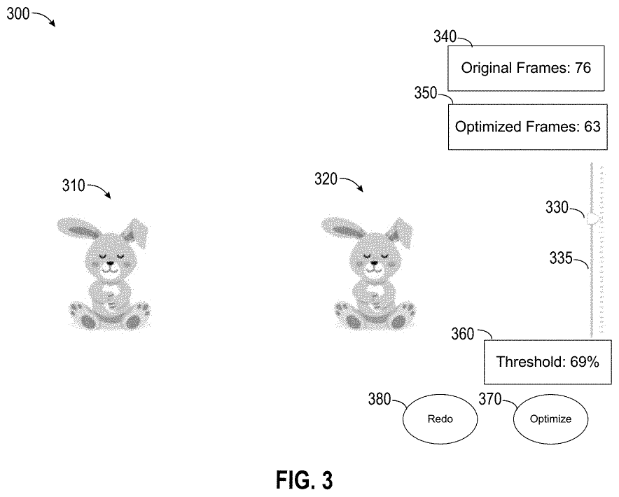

Based on the comparison of the second frame with the first frame, the method 200 may determine, at 235, whether the second frame is similar to (or in one implementation different from) the first frame. This may be done by applying an image compression threshold which may be predetermined and/or may be changeable. For example, a user may be able to change the percentage of similarities and/or difference allowed between each two frames by modifying the image compression threshold. The percentage of difference allowed corresponds to a degree of similarity between the two frames. For example, two frames may be determined as having an acceptable level of similarity (i.e., being identified as similar), if the similarities between them are above the image compression threshold. In a similar manner, the two frames may be determined as not having enough differences to be identified as different if the degree of differences between them are below the image compression threshold. Thus, the percentage of difference allowed between two frames is inversely proportional to the degree of similarities required between the two frames. This means that the method 200 may include comparing the second frame to the first frames to determine if a degree of similarities between the second frame and the first frame is above the threshold or a degree of differences between the second frame and the first frame is below the threshold. The image compression threshold may be changed, in one implementation, through a graphical user interface (GUI), such as the GUI 300 of FIG. 3, as discussed further below. If it is determined, at 235, that the second frame is not similar enough to the first frame, based on the image compression threshold, then method 200 may proceed to add the metadata tag for the second frame to the playback list in the metadata file, at 275. In an implementation that uses consecutive numbers for metadata tags that start at the number 1, this may result in a playback list that starts with 1, 2.

After adding the metadata tag for the second frame to the playback list, the Method 220 moves to step 250 to determine if there are any other frames in the file that need to be examined, as discussed further below. When it is determined, at 235, that the second frame is similar enough to the first frame, based on the image compression threshold, the method 200 may proceed to label the second frame as a repetitive frame by adding the metadata tag for the first frame to the playback list, at 240, instead of adding the metadata tag for the second frame. In an implementation that uses consecutive numbers for metadata tags that start at the number 1, this may result in a playback list that starts with 1, 1. As part of the compression process, the method 200 may then proceed to delete the second frame from the optimized file. This reduces the size of the optimized file, particularly if multiple frames are deleted.

Method 200 may then determine, at 250, if there are more frames in the original media file that should be examined and compared to the designated reference frames. If it is determined, at this step, that all frames have been examined, then the method 200 proceeds to end, at 280. However, if it is determined, at 250, that there more frames in the file that need to be examined, the method 200 compares the next frame in the file to all previous reference frames in the file, at 255. This is to ensure that every frame in the media file is compared to all non-repetitive frames. This can eliminate a much larger number of frames than is normally eliminated in currently available compression schemes, resulting in increased size reduction and greater speed and efficiency. The comparison with every non-repetitive frame is particularly advantageous in animation files that are repetitive or circular in nature (i.e., emoticon animations). For example, an animation file for a waving hand may include a number of frames for the hand moving frame from right to left and a number of frames for the hand moving from left to right. Even though, the direction is different, many of the frames in one direction may be similar to the frames in the other direction since they are repeating the same action. In other words, many of the still images of the hand will be similar when it is moving from right to left to when it is moving from left to right. As a result, by comparing all the frames to every other non-repetitive frame, a large number of those frames can be eliminated. This is different from currently available compression techniques where a frame is only compared to a few surrounding frames.

The comparison, at 255, may done in a similar manner as that of step 230 by comparing the frames pixel by pixel. Based on the comparison of the next frame with all previous reference frames, the method 200 may determine, at 260, whether the next frame (the frame currently being examined) is similar to any of the previous reference frames by applying the image compression threshold, which as discussed before, may be predetermined or changeable by a user. If it is determined, at 260, that the next frame is not similar enough to any of the previous reference frames (i.e., for a third frame, to any of the first reference frame or potentially second reference frame), based on the image compression threshold, then the method 200 may proceed to add the metadata tag for the next frame to the playback list in the metadata file, at 285. Method 200 then moves back to step 250 to determine if there are any other frames in the animation file that need to be examined.

When it is determined, at 260, that the next frame (the frame currently being examined) is similar enough to one of the previous reference frames, based on the image compression threshold, the method 200 may proceed to designate the next frame as a repetitive frame by adding the metadata tag for the reference frame to which it is similar to the playback list, at 265, instead of adding the metadata tag for the current frame. The method 200 may then proceed to delete the current frame from the optimized animation file to reduce the size of the optimized animation file. Method 200 may then move back to step 250 to determine if there are any other frames in the media file that need to be examined.

FIG. 3 depicts an exemplary GUI 300 for modifying the image compression threshold and reviewing the resulting changes. The GUI 300 may include a display of the original animation 310 and a display of the optimized animation 320, positioned on the same GUI and side by side, such that the user can review the changes and determine if they are acceptable, before finalizing the optimization. To modify the image compression threshold, the GUI 300 may include a movable button 330 that can be moved up and down a scale 335 to increase or decrease the threshold. A display box 360 may show the percentage of threshold as the movable button 330 moves up or down. Once the user, which may be a designer or animator of the animation, or an administrator responsible for optimizing the animation, chooses a threshold by placing the movable button on a desirable point on a particular position on the scale, an optimize button 370 may be pressed or otherwise selected to indicate the user's desire to perform optimization with the selected threshold. As a result, the optimized animation 320 changes based on the percentage of threshold, and a display box 350 displays the optimized number of frames in the optimized animation. In this manner, the user can change the compression threshold and immediately view the result in the optimized animation to determine whether or not the optimization affects the viewing quality of the animation. The user can then decide what threshold is appropriate for each animation. Alternatively, the image compression threshold may be pre-set based on, for example, empirical evidence of a number of tests run on various animation files.

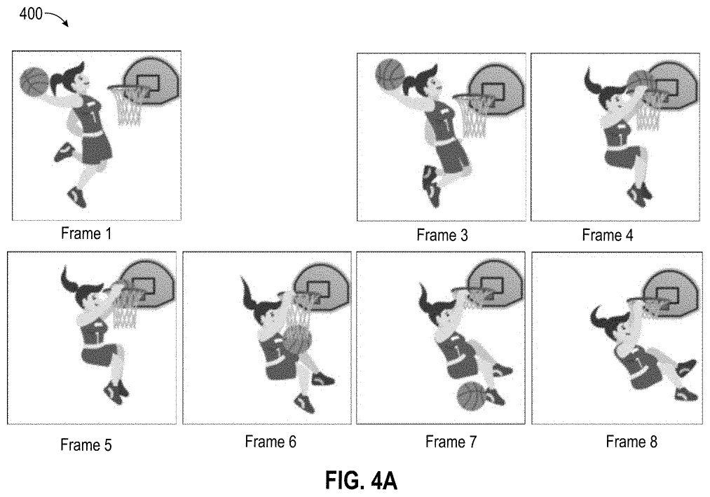

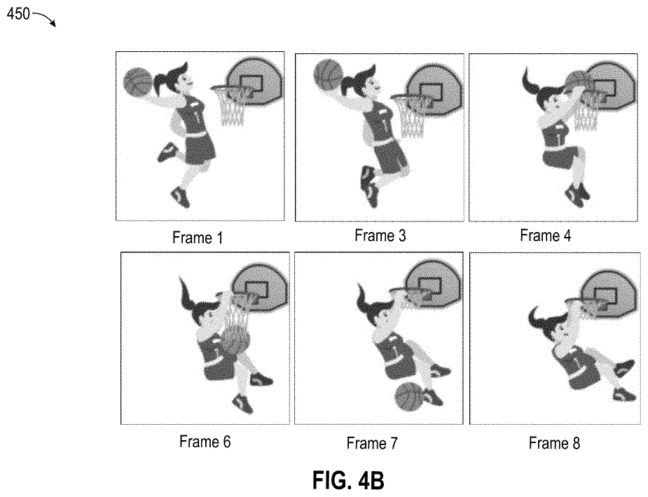

FIGS. 4A-4B are representations of two different optimized animation files for the unoptimized animation file 100 of FIG. 1. In FIG. 4A, the second frame, which was given the metadata tag frame 2, has been deleted from the optimized animation file 400, because frame 2 was determined to be similar enough to frame 1. None of the other frames, however, were determined to be close enough to any of the other frames based on the compression threshold used. As a result, the optimized animation file 400 includes 7 frames, instead of the original 8 frames. If all the frames in the animation file 100 are the same size, this optimization results in a 12.5% reduction in the size of the optimized animation file. To ensure that the optimized animation file 400 does not significantly change the viewer's viewing experience, the metadata file associated with the optimized animation file 400 would include a playback list sequence of: 1, 1, 3, 4, 5, 6, 7, 8. Therefore, the playback tool used for playing the optimized animation file 400 would play frame 1 twice before moving to frame 3.

FIG. 4B depicts a different optimized animation file 450 for the unoptimized animation file 100 of FIG. 1. In the optimized animation file 450, both frame 2 and frame 5 are determined to be similar enough to previous reference frames. This is different from the optimized animation file 400, because a different compression threshold was used for optimizing optimized animation file 450. For example, a 95% threshold may have been used in optimizing the optimized animation file 400, while a 85% threshold was used to optimize the animation file 450. As a result, more frames were identified as being repetitive and deleted in the optimized animation file 450, thus resulting in an increased reduction in size. By removing two frames out of eight, the optimized animation file 450 provides a potential 25% reduction in size. The metadata file associated with the optimized animation file 450 would include a playback list sequence of: 1, 1, 3, 4, 4, 6, 7, 8. Therefore, the playback tool used for playing the optimized animation file 450 would play frames 1 and 4 twice before moving to the next non-repetitive frame.

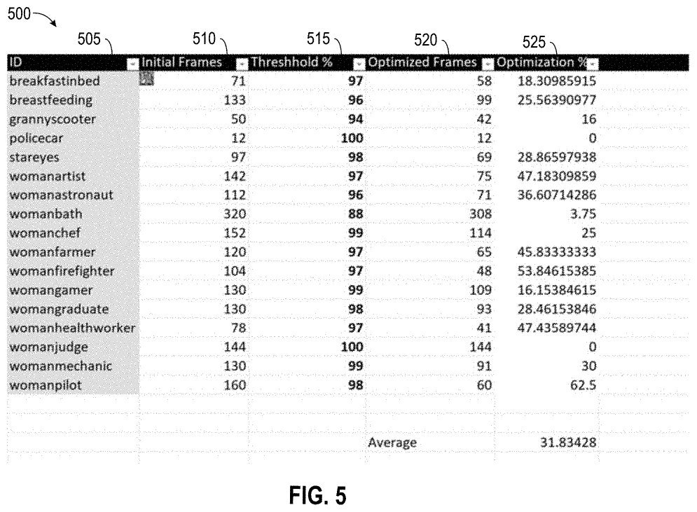

FIG. 5 is a table 500 depicting optimization parameters for a few example animation files optimized with the method for optimizing animation files discussed herein. Table 500 includes a column 505 for the ID or name of the animation file, a column 510 for the initial number of frames in each animation file, a column 515 for the compression threshold used in optimizing each animation file, a column 520 for the number of frames in the optimized version of each animation file, a column 525 for a percentage of optimization (i.e., the percentage by which the size of each animation file is reduced as a result of the optimization. As shown, using a 100% threshold may result in a 0% optimization (i.e., no repetitive frames are found), while using a threshold as high as 99% may result in a reduction of up to 30% or more. FIG. 5 shows that by using a range of compression thresholds on a variety of animation files, the average reduction in size is about 30%, which is significant, particularly given the large number of animation files transferred by various application providers and stored on personal computing devices. Thus, the method of optimizing animation files, discussed herein, can reduce the size of animation files without substantially modifying the quality of the animation as viewed by a user. This significantly reduces network and computing resources required for transmission and storage of animation files and thus results in significant time and costs savings.

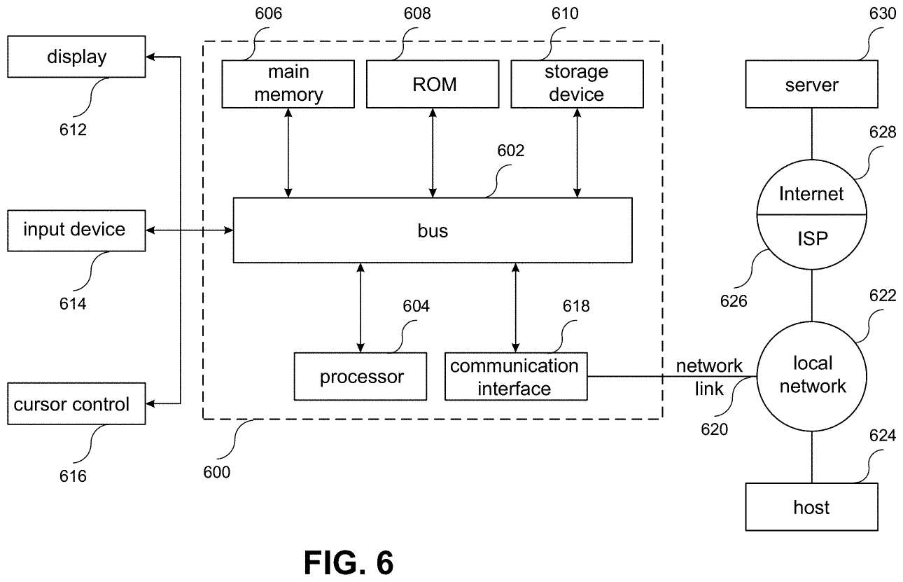

FIG. 6 is a block diagram showing an example computer system 600 upon which aspects of this disclosure may be implemented. Computer system 600 includes a bus 602 or other communication mechanism for communicating information, and a processor 604 coupled with bus 602 for processing information. Computer system 600 also includes a main memory 606, such as a random-access memory (RAM) or other dynamic storage device, coupled to bus 602 for storing information and instructions to be executed by processor 604. Main memory 606 also may be used for storing temporary variables or other intermediate information during execution of instructions to be executed by processor 604. The computer system 600 can implement, for example, one or more steps of the method 200 for optimizing an animation file or one or more steps of playback of an optimized animation file.

Computer system 600 can further include a read only memory (ROM) 608 or other static storage device coupled to bus 602 for storing static information and instructions for processor 604. A storage device 610, such as a flash or other non-volatile memory, can be coupled to bus 602 for storing information and instructions.

Computer system 600 may be coupled via bus 602 to a display 612, such as a liquid crystal display (LCD), for displaying information. One or more user input devices, such as the exemplary user input device 614 can be coupled to bus 602, and can be configured for receiving various user inputs, such as user command selections and communicating these to processor 604, or to a main memory 606. The user input device 614 can include physical structure, or virtual implementation, or both, providing user input modes or options, for controlling, for example, a cursor, visible to a user through display 612 or through other techniques, and such modes or operations can include, for example virtual mouse, trackball, or cursor direction keys.

The computer system 600 can include respective resources of processor 604 executing, in an overlapping or interleaved manner, respective program instructions. Instructions may be read into main memory 606 from another machine-readable medium, such as storage device 610. In some examples, hard-wired circuitry may be used in place of or in combination with software instructions. The term “machine-readable medium” as used herein refers to any medium that participates in providing data that causes a machine to operate in a specific fashion. Such a medium may take forms, including but not limited to, non-volatile media, volatile media, and transmission media. Non-volatile media can include, for example, optical or magnetic disks, such as storage device 610. Transmission media can include optical paths, or electrical or acoustic signal propagation paths, and can include acoustic or light waves, such as those generated during radio-wave and infra-red data communications, that are capable of carrying instructions detectable by a physical mechanism for input to a machine.

Computer system 600 can also include a communication interface 618 coupled to bus 602, for two-way data communication coupling to a network link 620 connected to a local network 622. Network link 620 can provide data communication through one or more networks to other data devices. For example, network link 620 may provide a connection through local network 622 to a host computer 624 or to data equipment operated by an Internet Service Provider (ISP) 626 to access through the Internet 628 a server 630, for example, to obtain code for an application program.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-5) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are platform-independent, meaning that the techniques may be implemented on a variety of computing platforms having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

1. A method for optimizing a media file comprising a plurality of sequential frames, wherein each of the frames is associated with a metadata tag, and the frames include a plurality of designated reference frames, the method comprising:
creating a metadata playback file for storing a playback list for use in playback;
comparing a next frame in the plurality of sequential frames to each one of the plurality of reference frames to determine if a degree of similarities between the next frame and one of the plurality of reference frames is above a threshold or a degree of differences between the next frame and the one of the plurality of reference frames is below the threshold;
upon determining that the degree of similarities between the next frame and one of the plurality of reference frames is above the threshold or the degree of differences between the next frame and the one of the plurality of reference frames is below the threshold, labeling the next frame as a repeated frame, deleting the repeated frame from the media file and inserting the metadata tag for the one of the plurality of reference frames in the playback list;
upon determining that the degree of similarities is below the threshold or the degree of differences is above the threshold, labeling the next frame as a next reference frame in the plurality of reference frames, and inserting the metadata tag for the next frame in the playback list; and
repeating the process of comparing the next frame in the plurality of sequential frames to each of the plurality of reference frames until all the frames in the plurality of sequential frames have been compared to all of the plurality of reference frames,
wherein comparing the next frame in the plurality of sequential frames to each one of the plurality of reference frames includes comparing the next frame to each one of the plurality of reference frames until the degree of similarities between the next frame and the one of the plurality of reference frames is determined to be above the threshold or the degree of differences between the next frame and the one of the plurality of reference frames is found to be below the threshold, or until the next frame has been compared to all the plurality of reference frames.

2. The method of claim 1, wherein the media file is an animation file.

3. The method of claim 2, further comprising creating a copy of the animation file as an optimized animation file, wherein the repeated frame is deleted from the optimized animation file, and not from the animation file.

4. The method of claim 3, further comprising providing a user interface on a display device, the graphical user interface displaying side by side views of the animation file and the optimized animation file.

5. The method of claim 1, wherein comparing the next frame in the plurality of sequential frames to one of the plurality of reference frames comprises comparing one or more properties of each pixel in the next frame with one or more properties of each pixel in the one of the plurality of reference frames, the one or more properties including transparency.

6. The method of claim 5, wherein when the next frame is labeled as a repetitive frame, the metadata tag for the one of the plurality of reference frames is inserted in the sequence of the metadata tags assigned to the frames instead of inserting the metadata tag assigned to the next frame.

7. The method of claim 1, further comprising enabling a user to adjust the threshold.

8. The method of claim 7, wherein enabling a user to adjust the threshold comprises providing a graphical user interface on a display device, the graphical user interface including a button for adjusting the threshold.

9. An apparatus comprising:
a processing unit; and
a memory readable by the processing unit and comprising instructions stored thereon to cause the processing unit to:
create a copy of a media file as an optimized media file;
assign a metadata tag to each frame in a plurality of sequential frames in the media file;
create a metadata playback file for storing a playback list for use in playback;
designate a first frame in the plurality of sequential frames as a first reference frame of a plurality of reference frames;
compare a next frame in the plurality of sequential frames to each one of the plurality of reference frames to determine if a degree of similarities between the next frame and one of the plurality of reference frames is above a threshold or a degree of differences between the next frame and the one of the plurality of reference frames is below the threshold;
upon determining that the degree of similarities between the next frame and one of the plurality of reference frames is above the threshold or the degree of differences between the next frame and the one of the plurality of reference frames is below the threshold, label the next frame as a repeated frame, delete the repeated frame from the optimized media file and insert the metadata tag for the one of the plurality of reference frames in the playback list;
upon determining that the degree of similarities is below the threshold or the degree of differences is above the threshold, label the next frame as a next reference frame in the plurality of reference frames, and insert the metadata tag for the next frame in the playback list; and
repeat the process of comparing the next frame in the plurality of sequential frames to each of the plurality of reference frames until all the frames in the plurality of sequential frames have been compared to all of the plurality of reference frames,
wherein comparing the next frame in the plurality of sequential frames to each one of the plurality of reference frames includes comparing the next frame to each one of the plurality of reference frames until the degree of similarities between the next frame and the one of the plurality of reference frames is determined to be above the threshold or the degree of differences between the next frame and the one of the plurality of reference frames is found to be below the threshold, or until the next frame has been compared to all the plurality of reference frames.

10. The apparatus of claim 9, wherein the media file is an animation file and the optimized media file is an optimized animation file.

11. The apparatus of claim 9, wherein comparing the next frame in the plurality of sequential frames to one of the plurality of reference frames comprises comparing one or more properties of each pixel in the next frame with one or more properties of each pixel in the one of the plurality of reference frames, the one or more properties including transparency.

12. The apparatus of claim 11, wherein when the next frame is labeled as a repetitive frame, the metadata tag for the one of the plurality of reference frames is inserted in the sequence of the metadata tags assigned to the frames instead of inserting the metadata tag assigned to the next frame.

13. The apparatus of claim 9, wherein instructions stored on the memory further cause the processing unit to enable a user to adjust the threshold.

14. The apparatus of claim 13, wherein enabling a user to adjust the threshold comprises providing a graphical user interface on a display device, the graphical user interface displaying side by side views of the media file and the optimized media file and including a button for adjusting the threshold.

15. An apparatus comprising:
a processing means; and
a memory means readable by the processing means and comprising instructions stored thereon to cause the processing means to:
create a copy of a media file as an optimized media file;
assign a metadata tag to each frame in a plurality of sequential frames in the animation file;
create a metadata playback file for storing a playback list for use in playback;
designate a first frame in the plurality of sequential frames as a first reference frame of a plurality of reference frames;
compare a next frame in the plurality of sequential frames to each one of the plurality of reference frames to determine if a degree of similarities between the next frame and one of the plurality of reference frames is above a threshold or a degree of differences between the next frame and the one of the plurality of reference frames is below the threshold;
upon determining that the degree of similarities between the next frame and one of the plurality of reference frames is above the threshold or the degree of differences between the next frame and the one of the plurality of reference frames is below the threshold, label the next frame as a repeated frame, delete the repeated frame from the optimized media file and insert the metadata tag for the one of the plurality of reference frames in the playback list;
upon determine that the degree of similarities is below the threshold or the degree of differences is above the threshold, label the next frame as a next reference frame in the plurality of reference frames, and insert the metadata tag for the next frame in the playback list; and
repeat the process of comparing the next frame in the plurality of sequential frames to each of the plurality of reference frames until all the frames in the plurality of sequential frames have been compared to all of the plurality of reference frames,
wherein comparing the next frame in the plurality of sequential frames to each one of the plurality of reference frames includes comparing the next frame to each one of the plurality of reference frames until the degree of similarities between the next frame and the one of the plurality of reference frames is determined to be above the threshold or the degree of differences between the next frame and the one of the plurality of reference frames is found to be below the threshold, or until the next frame has been compared to all the plurality of reference frames.

16. The apparatus of claim 15, wherein the media file is an animation file and the optimized media file is an optimized animation file.

17. The apparatus of claim 15, wherein the playback list includes a sequence of the metadata tags assigned to the frames.

18. The apparatus of claim 17, wherein when the next frame is labeled as a repetitive frame, the metadata tag for the one of the plurality of reference frames is inserted in the sequence of the metadata tags assigned to the frames instead of inserting the metadata tag assigned to the next frame.

19. The apparatus of claim 15, wherein instructions stored on the memory means further cause the processing means to enable a user to adjust the threshold.

20. The apparatus of claim 19, wherein enabling a user to adjust the threshold comprises providing a graphical user interface on a display device, the graphical user interface displaying side by side views of the media file and the optimized media file and including a button for adjusting the threshold.

21. A method for optimizing a media file comprising a plurality of sequential frames, wherein each of the frames is associated with a metadata tag, and the frames include a plurality of designated reference frames, the method comprising:
creating a metadata playback file for storing a playback list for use in playback;
comparing a next frame in the plurality of sequential frames to each one of the plurality of reference frames to determine if a degree of similarities between the next frame and one of the plurality of reference frames meets a threshold requirement;
upon determining that the degree of similarities between the next frame and one of the plurality of reference frames meets the threshold requirement, labeling the next frame as a repeated frame, deleting the repeated frame from the media file and inserting the metadata tag for the one of the plurality of reference frames in the playback list;
upon determining that the degree of similarities does not meet the threshold requirement, labeling the next frame as a next reference frame in the plurality of reference frames, and inserting the metadata tag for the next frame in the playback list; and
repeating the process of comparing the next frame in the plurality of sequential frames to each of the plurality of reference frames until all the frames in the plurality of sequential frames have been compared to all of the plurality of reference frames,
wherein comparing the next frame in the plurality of sequential frames to each one of the plurality of reference frames includes comparing the next frame to each one of the plurality of reference frames until the next frame has been compared to all of the plurality of reference frames.

22. The method of claim 21, wherein the media file is an animation file.

23. The method of claim 22, further comprising creating a copy of the animation file as an optimized animation file, wherein the repeated frame is deleted from the optimized animation file, and not from the animation file.

24. The method of claim 23, further comprising providing a user interface on a display device, the graphical user interface displaying side by side views of the animation file and the optimized animation file.

25. The method of claim 21, wherein comparing the next frame in the plurality of sequential frames to one of the plurality of reference frames comprises comparing one or more properties of each pixel in the next frame with one or more properties of each pixel in the one of the plurality of reference frames, the one or more properties including transparency.

26. The method of claim 25, wherein when the next frame is labeled as a repetitive frame, the metadata tag for the one of the plurality of reference frames is inserted in the sequence of the metadata tags assigned to the frames instead of inserting the metadata tag assigned to the next frame.

27. The method of claim 21, further comprising enabling a user to adjust the threshold.

28. A system comprising:
a processing unit; and
a memory readable by the processing unit and comprising instructions stored thereon to cause the processing unit to:
create a copy of a media file as an optimized media file;
assign a metadata tag to each frame in a plurality of sequential frames in the media file;
create a metadata playback file for storing a playback list for use in playback;
designate a first frame in the plurality of sequential frames as a first reference frame of a plurality of reference frames;
compare a next frame in the plurality of sequential frames to each one of the plurality of reference frames to determine if a degree of similarities between the next frame and one of the plurality of reference frames meets a threshold requirement;
upon determining that the degree of similarities between the next frame and one of the plurality of reference frames is meets the threshold requirement, label the next frame as a repeated frame, delete the repeated frame from the optimized media file and insert the metadata tag for the one of the plurality of reference frames in the playback list;
upon determining that the degree of similarities does not meets the threshold requirement, label the next frame as a next reference frame in the plurality of reference frames, and insert the metadata tag for the next frame in the playback list; and
repeat the process of comparing the next frame in the plurality of sequential frames to each of the plurality of reference frames until all the frames in the plurality of sequential frames have been compared to all of the plurality of reference frames,
wherein comparing the next frame in the plurality of sequential frames to each one of the plurality of reference frames includes comparing the next frame to each one of the plurality of reference frames until the next frame has been compared to all of the plurality of reference frames.

29. The system of claim 28, wherein the media file is an animation file and the optimized media file is an optimized animation file.

30. The apparatus of claim 28, wherein comparing the next frame in the plurality of sequential frames to one of the plurality of reference frames comprises comparing one or more properties of each pixel in the next frame with one or more properties of each pixel in the one of the plurality of reference frames, the one or more properties including transparency.

31. The system of claim 28, wherein when the next frame is labeled as a repetitive frame, the metadata tag for the one of the plurality of reference frames is inserted in the sequence of the metadata tags assigned to the frames instead of inserting the metadata tag assigned to the next frame.

32. The apparatus of claim 28, wherein instructions stored on the memory further cause the processing unit to enable a user to adjust the threshold.
